(19) United States
(12) Patent Application Publication
(10) Pub. No.: US 2025/0319752 A1
(43) Pub. Date: Oct. 16, 2025

(54) VEHICLE SUNVISOR ASSEMBLY

(71) Applicant: NISSAN NORTH AMERICA, INC., Franklin, TN (US)

(72) Inventor: Jake PRUSAKIEWICZ, Novi, MI (US)

(21) Appl. No.: 18/633,065

(22) Filed: Apr. 11, 2024

(51) Int. Cl. B60J 3/02; B60R 13/02; B60R 21/214; B60R 21/232

(52) U.S. Cl. CPC B60J 3/0252; B60R 13/0212; B60R 21/214; B60R 21/232

(57) ABSTRACT

A vehicle sunvisor assembly includes a panel body, a first vehicle attachment and a second vehicle attachment. The panel body includes a first panel portion and a second panel portion. The first vehicle attachment is movably coupled to a first end of the panel body, and attached to a vehicle body structure. The second vehicle attachment is coupled adjacent a second end of the panel body, and is releasably coupled to the vehicle body structure. The panel body includes at least one of a frangible connection and a living hinge connection that connects the first portion to the second portion. The frangible connection breaks in response to a force greater than a predetermined amount being applied to the first panel portion. The living hinge connection bends in response to a force greater than a predetermined amount being applied to the first panel portion.

### BACKGROUND

### Technical Field

The present disclosure generally relates to vehicle sunvisor assembly. More specifically, the present disclosure relates to vehicle sunvisor assembly that includes at least one of a frangible connection and a living hinge connection that absorbs downward momentum (energy) in response to a curtain airbag moving in a downward direction contacting a headliner and sunvisor assembly imparting the downward momentum into the panel body and the at least one of a frangible connection and a living hinge connection.

### Background Information

The automotive industry is constantly re-engineering and re-designing many of the components and structures within a vehicle in order to absorb energy in the form of downward momentum of objects within the vehicle. One area of re-designing interest relates to considering the effects of a curtain airbag deployment on the surrounding structures.

### SUMMARY

Generally, the present disclosure is directed to various features of a vehicle sunvisor assembly.

It has been discovered that in order to dissipate energy from a curtain airbag in some vehicle configurations, a sunvisor assembly can be provided with a frangible connection.

In view of the state of the known technology, one aspect of the present disclosure is to provide a vehicle sunvisor assembly including a panel body, a first vehicle attachment and a second vehicle attachment. The panel body including a first panel portion and a second panel portion. The panel body having a first side and a second side spaced from the first side. The first vehicle attachment movably coupled to a first end of the first side, and configured to be attached to a vehicle body structure. The second vehicle attachment coupled adjacent a second end of the first side, and configured to be releasably coupled to the vehicle body structure. The panel body further including at least one of a frangible connection and a living hinge connection that connects the first portion to the second portion. The frangible connection being configured to break in response to a force greater than a predetermined amount being applied to the first panel portion, and the living hinge connection being configured to bend in response to a force greater than a predetermined amount being applied to the first panel portion.

Also, other objects, features, aspects and advantages of the disclosed vehicle sunvisor assembly will become apparent to those skilled in the art from the following detailed description, which, taken in conjunction with the annexed drawings, discloses preferred embodiments of the vehicle sunvisor assembly.

### BRIEF DESCRIPTION OF THE DRAWINGS

Referring now to the attached drawings which form a part of this original disclosure, an illustrative embodiment is shown.

FIG. 1 is a partial perspective view of an interior portion of the vehicle showing a windscreen, instrument panel, steering wheel, a headliner, a roof structure, a curtain airbag and the unbroken frangible connection in the stowed configuration in accordance with a first embodiment.

FIG. 2 is another partial perspective view of an interior portion of the vehicle showing the curtain airbag in the expanded configuration where the frangible connection of the vehicle sunvisor assembly has been broken in accordance with the first embodiment.

FIG. 3 is a partial rear cross-sectional view of a portion of a roof structure of the vehicle showing details of a first vehicle attachment and a second vehicle attachment of the sunvisor assembly in accordance with the first embodiment.

FIG. 4 is a bottom view of an interior portion of the vehicle showing details of the first attachment, the second attachment and the stowed curtain airbag in accordance with the first embodiment where the frangible connection is indicated by a dashed line.

FIG. 5 is a plan view of the vehicle sunvisor assembly showing the first attachment, the second attachment and the mirror assembly in accordance with the first embodiment where the frangible connection is indicated by a dashed line.

FIG. 6 is a plan view of the first panel part and the second panel part of the vehicle sunvisor assembly in a state prior to being folded the interior surface of the first panel part and the second panel part showing the first frangible section, the second frangible section and the opening for the mirror assembly of the vehicle sunvisor assembly in accordance with the first embodiment.

FIG. 7 is a partial cross-sectional view of a portion of the vehicle and a portion of the vehicle sunvisor assembly showing the headliner in dashed lines, the curtain airbag in dashed lines, the panel body in the area of the frangible connection in accordance with the first embodiment illustrated in FIGS. 1-2 as seen along section line 7-7 in FIG. 4.

FIG. 8 is a partial perspective view of a portion of the second panel part showing various features such as the first frangible section and the interior walls that are provided to the interior surface of the first panel part of the vehicle sunvisor assembly in accordance with the first embodiment.

FIG. 9 is an enlarged cross-sectional view of a portion of the first panel part showing the first frangible section and the interior walls of the vehicle sunvisor assembly in accordance with the first embodiment illustrated in FIGS. 1 and 2 as seen along section line 9-9 in FIG. 8.

FIG. 10 is a partial cross-sectional view, similar to FIG. 7, of a portion of the vehicle and a portion of a vehicle sunvisor assembly in accordance with a second embodiment in which the headliner is shown in dashed lines, and an area of the panel body is shown that includes a first frangible section and a second living hinge section.

FIG. 11 is a partial cross-sectional view, similar to FIGS. 7 and 10, of a portion of the vehicle and a portion of a vehicle sunvisor assembly in accordance with a third embodiment in which the headliner is shown in dashed lines, and an area of the panel body is shown that includes a first living hinge section and a second living hinge section.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

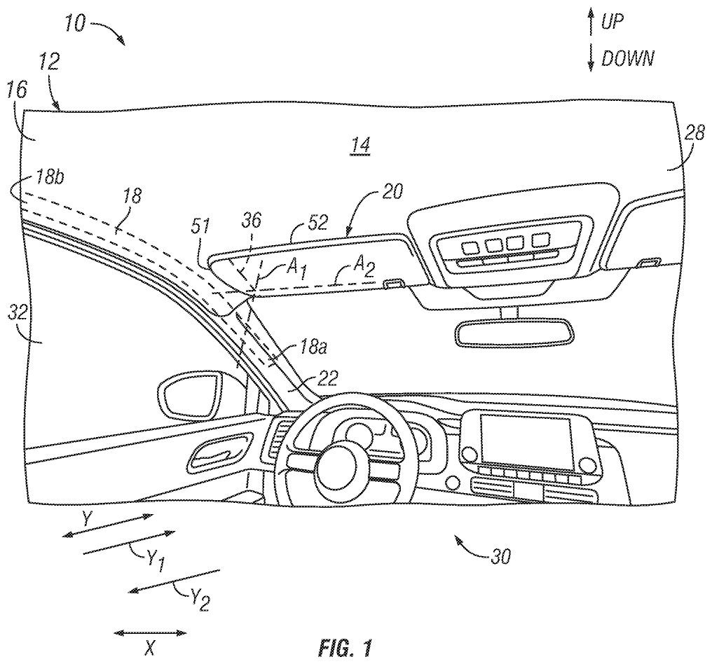

Referring initially to FIG. 1, a vehicle 10 having a vehicle body structure 12 that includes a roof structure 14, a headliner 16, a curtain airbag 18 and a sunvisor assembly 20 is illustrated in accordance with a first embodiment. In addition, the vehicle body structure 12 includes many conventional features, such as an A-pillar 22. Since A-pillars are conventional vehicle structures and components, further description is omitted for the sake of brevity. Basically, the vehicle 10 has a lateral direction X and a lengthwise direction Y (see FIG. 1). The lengthwise direction Y includes a forward direction Y1 and the rearward direction Y2.

The roof structure 14 includes a roof panel assembly 28, a plurality of roof bows (not shown), and two roof rails (not shown). Since roof panel assemblies, roof bow and roof rails are conventional vehicle structures and components, further description is omitted for the sake of brevity.

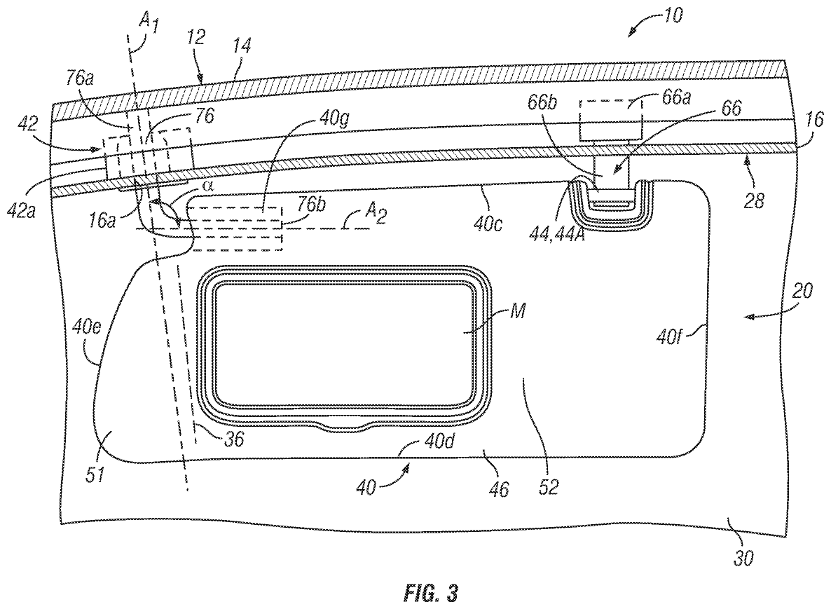

The headliner 16 is attached to the roof structure 14 with several fasteners (not shown). The headliner 16 conceals the roof rails, the roof bows, the curtain airbag 18 and roof panel assembly 28 from view within a passenger compartment 30 of the vehicle body structure 12. Stated differently, the headliner 16 is attached below the curtain airbag 18. The headliner 16 is installed along an interior side of the roof structure 14. The headliner 16 includes a first opening 16a and a second opening 16b (see FIG. 3), as described further herein below. Since headliners are conventional vehicle structures and components, further description is omitted for the sake of brevity.

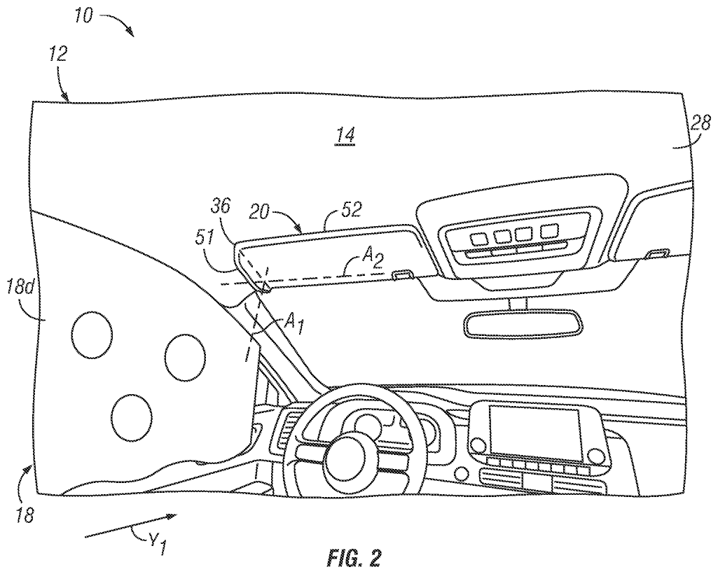

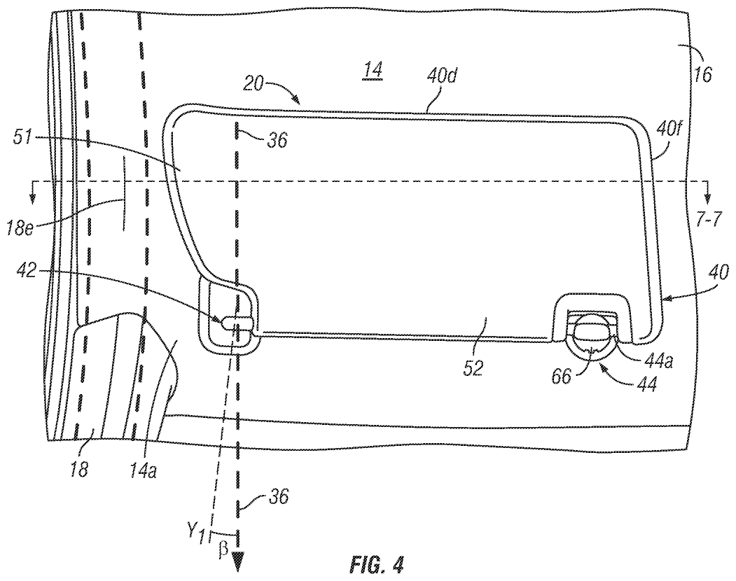

Referring to FIGS. 1, 2 and 4, the curtain airbag 18 is attached along the lateral side 14a of the roof structure 14 and an A-pillar body structure (not shown) (see FIG. 4). Stated differently, the curtain airbag 18 is attached to an area adjacent to the roof structure 14. As shown in FIGS. 1 and 2, the curtain airbag 18 has a stowed configuration (FIG. 1) and an expanded configuration (FIG. 2).

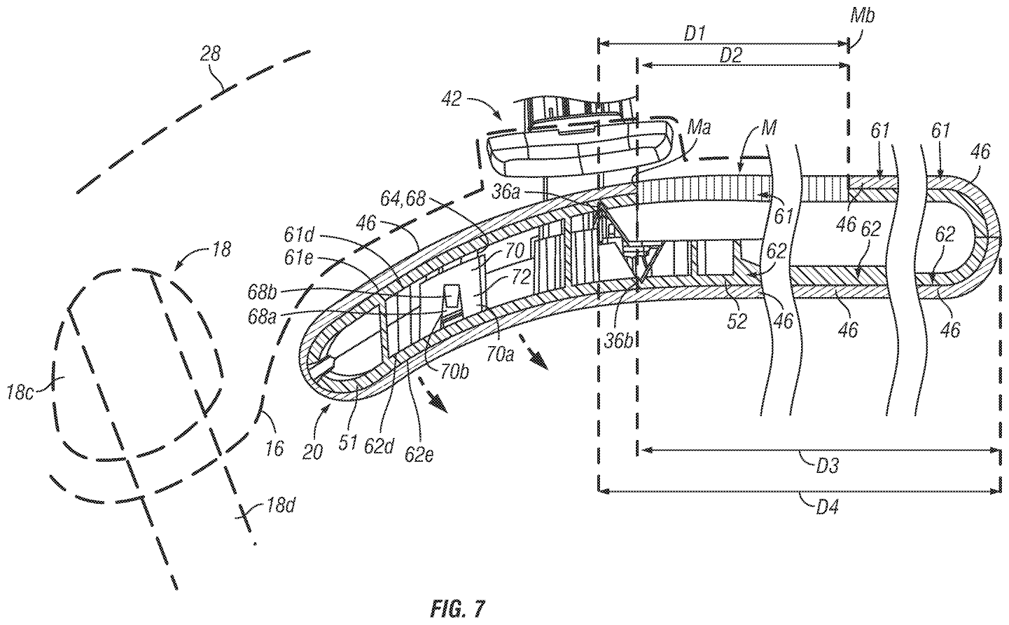

In the stowed configuration, the curtain airbag 18 has a cylindrical shape 18c, (see FIGS. 1 and 7). The curtain airbag 18 has a first end 18a and a second end 18b (see FIG. 1). The first end 18a of the curtain airbag 18 is attached to the A-pillar body structure and the second end 18b is attached to the roof structure 14. The headliner 16 is attached to the roof structure 14 to conceal the second end 18b of the curtain airbag 18. An A-pillar trim panel of the A-pillar 22 is attached to the A-pillar body structure of the A-pillar 22 to conceal the first end 18a of the curtain airbag 18.

When the curtain airbag 18 is triggered by an impact event (or other triggering event), the curtain airbag 18 is deployed from the stowed configuration to the expanded configuration. During deployment, the curtain airbag 18 inflates and changes from a cylindrical shape 18c to a curtain shape 18d (see FIGS. 2 and 7). In the expanded configuration, the curtain airbag 18 overlays a portion of the interior surface of a first row door window 32 (see FIG. 1) and the interior surface of a second row door window (not shown). In other words, the curtain airbag 18 has a stowed configuration concealed above the headliner 16 and an expanded configuration extending below the headliner 16. During deployment, the curtain airbag 18 applies a downward force to the headliner 16 and the sunvisor assembly 20. The force on the sunvisor assembly 20 breaks a frangible connection 36 (as described further herein below). Since curtain airbags are conventional vehicle structures and components, further description is omitted for the sake of brevity.

The sunvisor assembly 20 (also referred to as the vehicle sunvisor assembly 20) is now described with reference to FIGS. 3-9. The sunvisor assembly 20 includes a panel body 40, a first vehicle attachment 42, and a second vehicle attachment 44, a sleeve 46 and a vanity mirror assembly M (see FIGS. 3 and 7).

Referring to FIGS. 3-5, the panel body 40 is a generally rectangular shaped element. The panel body 40 basically includes a first panel portion 51 and a second panel portion 52 (see FIG. 3). In the first embodiment, the panel body 40 further includes at least one frangible connection 36 that connects the first panel portion 51 to the second panel portion 52. The frangible connection 36 is configured to break in response to a force greater than a predetermined amount being applied to the first panel portion 51.

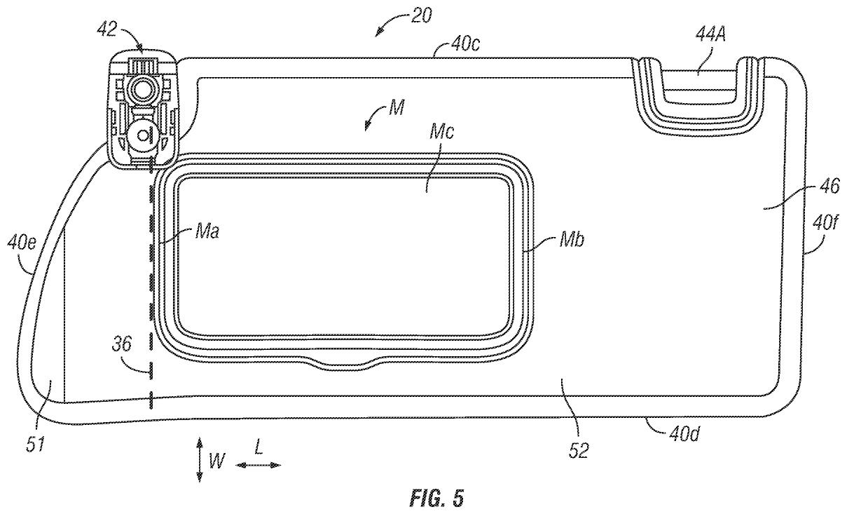

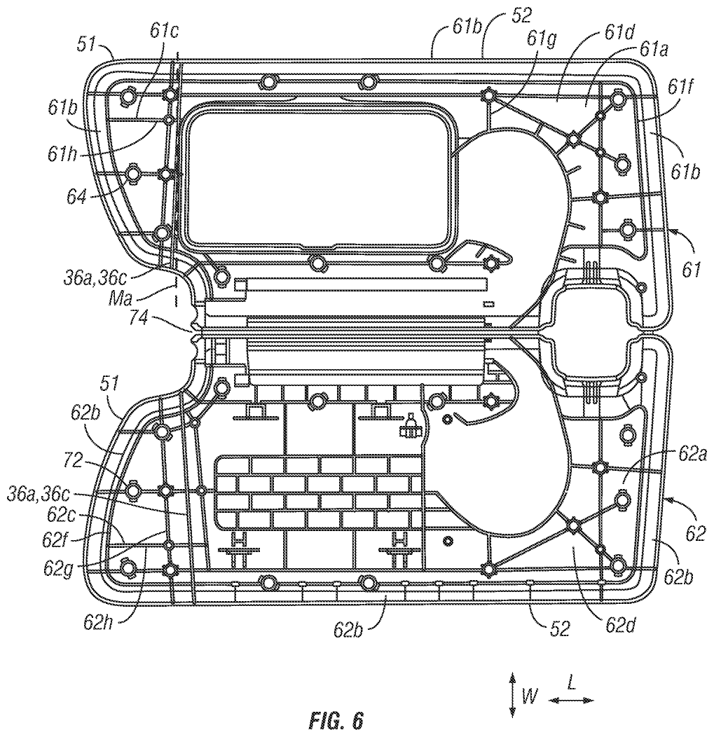

In the first embodiment, the panel body 40 includes a first panel part 61 and a second panel part 62 (see FIG. 6). The first panel part 61 at least partly defines the first panel portion 51 and the second panel portion 52. Also, the second panel part 62 at least partly defines the first panel portion 51 and the second panel portion 52. The panel body 40 has a first side 40c (vehicle forward side) and a second side 40d spaced from the first side 40c (see FIG. 5). The panel body 40 defines a first end 40e and a second end 40f. Further, the panel body 40 has a longitudinal direction L and a width direction W.

The frangible connection 36 includes a first frangible section 36a and a second frangible section 36b (see FIG. 6). More specifically, the frangible connection 36 includes the first frangible section 36a in the first panel part 61 (see FIGS. 6 and 7). The frangible connection 36 includes the second frangible section 36b in the second panel part 62 (as described further herein below).

Referring to FIGS. 1 and 3, the panel body 40 with the first vehicle attachment 42 are dimensioned and constructed to undergo pivotal movement about an upright axis A1, as described below. The first end 40e is a shaft receiving end that is further dimensioned and constructed to undergo pivotal movement about an offset axis A2 that is not parallel to the upright axis A1, as is also described in greater detail below (see FIG. 3). The second end 40f includes or defines a second vehicle attachment 44 that is also described in greater detail below.

Referring to FIGS. 5-7, the first panel part 61 includes a first body 61a, first perimeter wall 61b at least one first interior reinforcement wall 61c and at least one first snap fit connection portion 64 (see FIG. 6). The first panel part 61 includes a first interior surface 61d and a first exterior surface 61c. The first frangible section 36a is provided on the first interior surface 61d of the first panel part 61. The first body 61a of the first panel part 61 has a generally planar, rectangular shape and extends laterally across the vehicle 10. The first panel part 61 is ridged and formed of a plastic or polymer material. The first perimeter wall 61b is a curved wall extending from a portion of the perimeter of the first body 61a of the first panel part 61 (see FIG. 6). The first perimeter wall 61 b has a generally concave cross section. In the first embodiment, the first panel part 61 includes a plurality of the first interior reinforcement walls 61c and a plurality of the first snap fit connection portions 64.

The first frangible section 36a includes a channel 36c or sequence of channels within the first interior surface 61d of first body 61a of the first panel part 61 (see FIG. 6). Stated differently, the first frangible section 36a includes the channel 36c on the first interior surface 61d of the first panel part 61. The first frangible section 36a is more easily broken than portions of the first body 61a of the first panel part 61 that are adjacent to the channel 36c.

The curtain airbag 18 is configured to apply at least the predetermined force to the first panel portion 51 as the curtain airbag 18 transitions from the stowed configuration to the expanded configuration (see FIGS. 2 and 7). The first frangible section 36a dissipates energy from the curtain airbag 18 when the curtain airbag 18 is deployed.

Referring to FIGS. 7-9, a cross section of the channel 36c taken transversely to the channel 36c has a V shape or a U shape. Alternatively, the channel 36c can be a score line or sequential dimples extending in a line. Alternatively, the channel 36c can be located in the first exterior surface 61e of the first panel 61. In another alternative, the channels 44c can be located in the first interior surface 61d and in the first exterior surface 61e of the first panel part 61.

As shown in FIG. 4, the panel body 40 has a stored configuration. In the stored configuration, an attachment rod 44A is attached to a projection member 66 and the second side 40d of the panel body 40 is adjacent to headliner 16. In the stored configuration, the first frangible section 36a and the lengthwise direction Y define an angle β therebetween that is between 30 and −30 degrees (see FIG. 4). More preferably, the angle β is approximately between 15 and −15 degrees. In other words, the frangible section 36a is provided to at least one of the first interior surface 61d and the second interior surface 61e, and the frangible section 36a extends in a direction that is approximately parallel to a medial line 18e of a section of the stowed curtain airbag 18 that is adjacent to the panel body 20 where the panel body 40 is in a panel body stored configuration (see FIG. 4).

Referring to FIG. 6, the first interior reinforcement walls 61c includes a first perimeter reinforcement wall 61f, at least one first widthwise reinforcement wall 61g and at least one first longitudinal reinforcement wall 61h. The first perimeter reinforcement wall 61f extends along a portion of the perimeter of the first panel part 61. The first perimeter reinforcement wall 61f is attached to the first interior surface 61d of the first panel part 61. The at least one longitudinal reinforcement walls 61h extend in the longitudinal direction L on the first interior surface 61d of the first panel part 61.

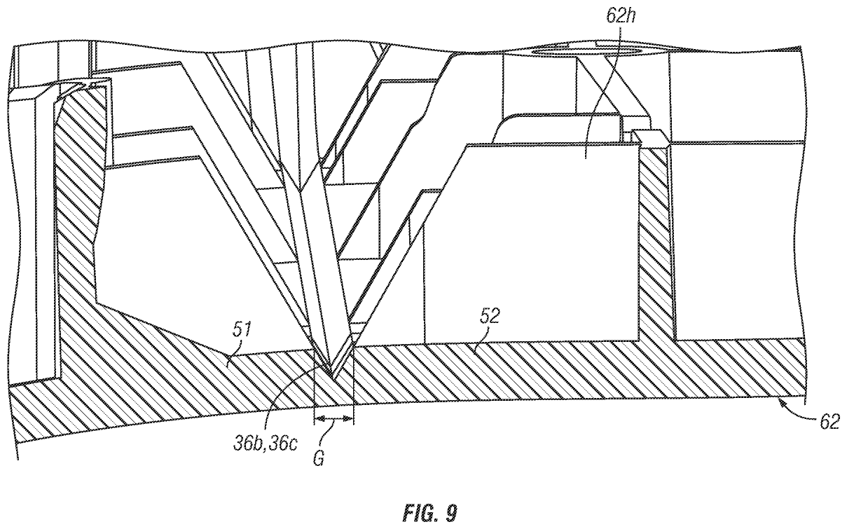

In addition, the first interior surface 61d of the first panel part 61 includes at least one interior reinforcement wall (also called first longitudinal reinforcement wall 61h) extending transverse to the frangible section 36a, the at least one interior reinforcement wall is discontinuous adjacent to the frangible section 36a. Stated differently, the at least one first longitudinal reinforcement wall 61h is formed on the first interior surface of the first panel part 61 and the at least one first longitudinal reinforcement wall 61h is not included adjacent to the first frangible section 42a. In other words, a gap G in the at least one first longitudinal reinforcement wall 61h is adjacent to the first frangible section 42a (see FIG. 9). While FIG. 9 shows a gap G in the second panel part 62, a similar gap G is also present in first panel part 61.

Referring to FIG. 6, the at least one first widthwise reinforcement wall 61g extends in the widthwise direction W on the first interior surface 61a of the first panel part 61. The at least one first interior reinforcement walls 61c are rigid and formed of plastic or a polymer material.

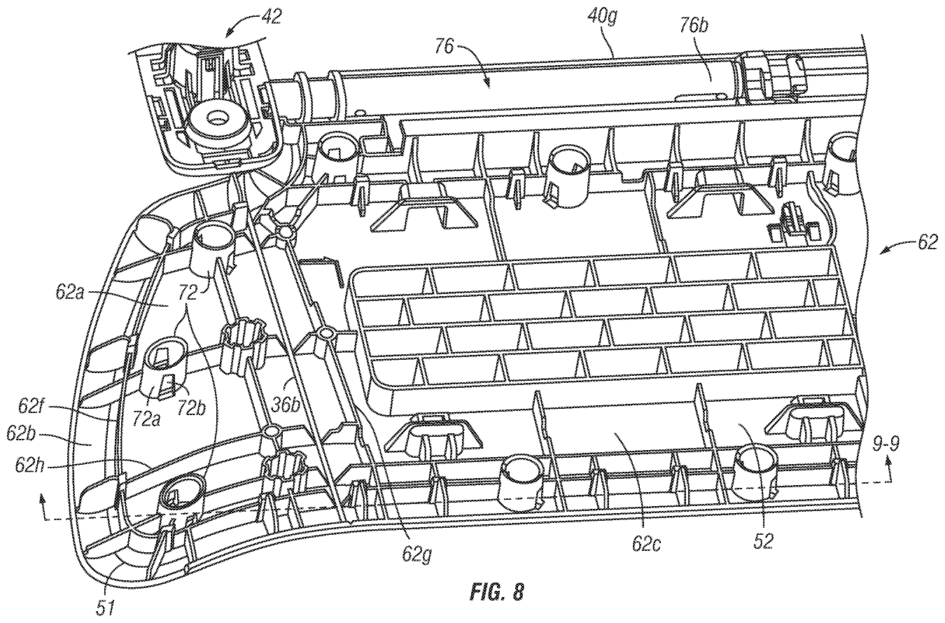

Referring to FIGS. 7 and 8, each of the first snap fit connection portions 64 includes a projection 68 (see FIG. 7). The projections 68 are attached to the first interior surface 61d of the first panel part 61. The projections 68 are received by a plurality of catches 70 on the second panel part 62. The projections 68 attached to the catches 70 define a plurality of snap fit connections. In this particular embodiment, the projection 68 is a cylindrical wall 68a extending from the interior surface 61d of the first panel part 61. A barb 68b of the cylindrical wall 68a is received by an opening 70b of the catches 70.

Referring to FIGS. 5-7, the second panel part 62 includes a second body 62a, a second perimeter wall 62b, at least one second interior reinforcement wall 62c and at least one second snap fit connection portion 72 (see FIG. 6). In the first embodiment, the second panel part 62 includes a plurality of the second interior reinforcement walls 62c and a plurality of the second snap fit connection portions 72. The second panel part 62 includes a second interior surface 62d and a second exterior surface 62e (see FIG. 7). The second frangible section 36b is provided on the second interior surface 62d of the second panel part 62. Also, the catches 70 are provided on the second interior surface 62d. The second body 62a of the second panel part 62 has a generally planar, rectangular shape and extends laterally across the vehicle 10. The second panel part 62 is ridged and formed of a plastic or polymer material. The second perimeter wall 62b is a curved wall extending from the perimeter of the second body 62a of the second panel part 62. The second perimeter wall 62b has a generally concave cross section.

Referring to FIGS. 6-9, the second frangible section 36b includes a channel 36c or sequence of channels within the second interior surface 62d of the second panel part 62 (see FIG. 7). The second frangible section 36b is more easily broken than portions of the second body 62a of the second panel part 62 that are adjacent to the channel 45c. The second frangible section 36b dissipates energy from the curtain airbag 18 when the curtain airbag 18 is deployed (see FIG. 2). The second frangible section 36b includes a channel 36c on the second interior surface 62d of the second panel part 62 (see FIGS. 7 and 9). A cross section of the channel 36c taken transversely to the channel 36c has a V shape or a U shape.

Alternatively, the channel 36c can be a score line or sequential dimples extending in a line. In yet another alternative, the channels can be located in the second exterior surface 62e of the second panel part 62. In another alternative, the channels 36c can be located in the second interior surface 62d and in the second exterior surface 62e of the second panel part 62.

Referring to FIGS. 5 and 7, the mirror assembly M has a first end Ma and a second end Mb, where the frangible connection 36 is disposed closer to the first end Ma. Here, in the first embodiment, the first frangible section 36a and the second frangible section 36b are laterally offset from each other. Thus, the first frangible section 36a and the second frangible section 36b are spaced at different differences from the mirror assembly M. Stated differently, the second end Mb of the mirror assembly M is spaced from the first frangible section 36a by a first lateral distance D1, and the second end Mb of the mirror assembly M is spaced from the second frangible section 36b by a second lateral distance D2. The first lateral distance D1 is greater than the second lateral distance D2.

Preferably, the first frangible section 36a is approximately parallel to the second frangible section 36b (see FIG. 6). The first frangible section 36a and the second frangible section 36b are approximately parallel to the first end Ma of the mirror assembly M (see FIG. 6). The second end 40f of the panel body 40 and the first frangible section 36a are spaced apart in the longitudinal direction L by a third distance D3 (see FIG. 6). The second end 40f of the panel body 40 and the second frangible section 36b are spaced apart in the longitudinal direction L by a fourth distance D4. The fourth distance D4 is approximately 5 mm to 40 mm greater than the third distance D3. The offset allows the curtain airbag 18 to break the first frangible section 36a before the second frangible section 36b in some vehicle configurations.

Referring to FIG. 6, the second interior reinforcement walls 62c include a second perimeter reinforcement wall 62f, at least one second widthwise reinforcement wall 62g and at least one second longitudinal reinforcement wall 62h. In the first embodiment, a plurality of the second widthwise reinforcement walls 62g and a plurality of the second longitudinal reinforcement walls 62h are provided to the second panel part 62. The second perimeter reinforcement wall 62f extends along a portion of the perimeter of the second panel part 62. The second perimeter reinforcement wall 62f is attached to the second interior surface 62d of the second panel part 62. The second longitudinal reinforcement walls 62h extend in the longitudinal direction L on the second interior surface 62d of the second panel part 62. In the first embodiment, the second longitudinal reinforcement walls 62h is not included adjacent to the second frangible section 36b.

In addition, referring to FIG. 6, the second interior surface 62d of the second panel part 62 includes at least one interior reinforcement wall 62c extending transverse to the frangible section 36b. In the first embodiment, a plurality of the interior reinforcement wall 62c are provided to the second interior surface 62d of the second panel part 62. The interior reinforcement walls 62c are discontinuous adjacent to the frangible section 36b. Stated differently, the second longitudinal reinforcement walls 62h is not included adjacent to the second frangible section 36b. In other words, a gap G in the second lateral reinforcement wall 62h is adjacent to the second frangible section 36b (see FIG. 9).

Referring to FIG. 6, the at least one second widthwise reinforcement wall 62g extends in the widthwise direction on the second interior surface 62d of the second panel part 62. The at least one second interior reinforcement walls 62c are rigid and formed of plastic or a polymer material.

Referring to FIGS. 6 and 7, as mentioned above, each of the second snap fit connection portions 72 includes one of the catches 70 (see FIG. 7). The catches 70 are attached to the second interior surface 62d of the second panel part 62. The catches 70 receive the projections 68 defining a plurality of snap fit connections. In this particular embodiment, the catch 70 is a cylindrical wall 70a extending from the second interior surface 62d of the second panel part 62. The cylindrical wall 70a includes the opening 70b. The cylindrical wall of the projection 68 has a smaller diameter than the cylindrical wall of the catch 70. The cylindrical wall of the projection 68 fits within the cylindrical wall of the catch 70 allowing the barb 68b of the projection 68 to be received by the opening in the catch 70.

While FIG. 7 shows the projections 68 are attached to the first interior surface of the first panel part 61 and the catches 70 are attached to the second interior surface of second panel part 62, in an alternate embodiment, the projections 68 are attached to the second interior surface of the second panel part 62 and the catches 70 are attached to the first interior surface of the first panel part 61. Stated differently, one of the first interior surface 61d and the second interior surface 62d includes a plurality of the projections 68 and the other of the first interior surface 61d and the second interior surface 62d includes a plurality of the catches 70 for receiving the projections 68 to form snap-fit connections. In yet another alternative, other snap fit connections can be used to fasten the first panel part 61 to the second panel part 62.

Referring to FIG. 6, the first panel part 61 of the panel body 40 and the second panel part 62 of the panel body 40 are a single, monolithic, unitary part. The first side 40c of the panel body 40 includes a living hinge portion 74. The living hinge portion 74 connects the first panel part 61 and the second panel part 62 (see FIG. 6). The first panel part 61 and the second panel part 62 define a partly hollow interior within the panel body 40. Alternatively, the first panel part 61 of the panel body 40 and the second panel part 62 of the panel body 40 are separate, distinct parts. In this alternative, the first panel part 61 and the second panel part 62 are identical to those shown in FIG. 6 except the first panel part 61 and the second panel part 62 are not connected by the living hinge portion 74.

In another alternative, the panel body 40 is a unitary, monolithic part. The panel body 40 has a first exterior surface and a second exterior surface. In this alternative, a frangible section 36 is provided on at least one of the first exterior surface and the second exterior surface of the panel body 40.

Referring to FIG. 3, the first vehicle attachment 42 of the sunvisor assembly 20 includes a base member 42a and an L-shaped shaft member 76. The base member 42a is attached to the headliner 16 and/or the roof structure 14 via a snap-fitting structure (not shown) and/or a fastener (not shown).

Referring to FIGS. 3, 4 and 6, the L-shaped shaft member 76 has a first end portion 76a and a second end portion 76b (see FIG. 3). The first end portion 76a extends through the base member 42a and is supported therein for pivotal movement about the upright axis A1. The upright axis A1 does not need to be vertical, but can be slightly inclined relative to vertical, depending upon the overall shape and design of the vehicle body structure 12 of the vehicle 10. In the depicted embodiment, the upright axis A1 is included relative to vertical by an angle that is approximately 5 degrees relative to vertical but can be anywhere between 0 and 10 degrees.

The second end portion 76b of the L-shaped shaft member 76 along with the first side 40c of the panel body 40 define the offset axis A2 such that the panel body 40 pivots about the offset axis A2 and the second end portion 76b of the L-shaped shaft member 76 (see FIG. 3).

The first end portion 76a and the second end portion 76b of the L-shaped shaft member 76 define an angle α therebetween that is between 80 and 100 degrees (see FIG. 3). However, in the depicted embodiment, the angle α is approximately 90 degrees or can be slightly larger than 90 degrees, depending upon the design of the vehicle body structure 12 of the vehicle 10.

The first end portion 76a of the L-shaped shaft member 76 extends through the base member 42a of the first vehicle attachment 42 (see FIG. 3). The upright axis A1 is defined by the base member 42a with the first end portion 76a of the L-shaped shaft member 76 being retained within the base member 42a for pivotal movement in a conventional manner. Stated differently, the panel body 40 is configured to pivot about the first end portion 76a of the L-shaped shaft member 76.

The second end portion 76b of the L-shaped shaft member 76 extends into an opening (not shown) in the first end 40e of the panel body 40 and into a second shaft receiving section 40g of the panel body 40, as shown in phantom in FIG. 3. Stated differently, the second end portion 76b of the L-shaped shaft member 76 extends into an opening extending along the first side 40c of the panel body 40. Hence, the panel body 40 can undergo pivotal movement about the offset axis A2 via the attachment to the second end portion 76b of the L-shaped shaft member 76.

In the depicted embodiment, the second vehicle attachment 44 at the second end 40f of the panel body 40 includes an attachment rod 44A that can be aligned with the offset axis A2 (see FIG. 3). In the depicted embodiment, the attachment rod 44A is separate and spaced apart from the second end portion 76b of the L-shaped shaft member 76. Stated differently, the attachment rod 44A extends parallel to the first side 40c of the panel body 40. In addition, in the depicted embodiment, the attachment rod 44A is formed of a plastic, metal or plastic molded over metal. The attachment rod 44A is held between the first panel part 61 and the second panel part 62. Alternatively, the attachment rod 44A can be formed unitarily with the panel body 40.

However, in an alternative embodiment (not shown) the attachment rod 44A can be part of the L-shaped shaft member 76 and is a distal end of the second end portion 76b of the L-shaped shaft member 76. Still further, in a further alternative embodiment, the attachment rod 44A is separate from the L-shaped shaft member 76, and is not aligned with the second axis A2.

Referring to FIG. 3, the projection member 66 includes an upper end 66a and a second attachment end 66b. The upper end 66a attaches to the roof structure 14. Projection member 66 extends downwardly through a second opening 16b in the headliner 16. The second attachment end 66b has a hook shape. The attachment rod 44A is sized and dimensioned to snap fit into the second attachment end 66b. Since the projection member 66 is a conventional vehicle structure and component, further description is omitted for the sake of brevity.

Referring to FIGS. 4 and 7, the sleeve 46 is rectangularly shaped and encloses the panel body 40 (see FIG. 4). Stated differently, the sleeve 46 surrounds the first panel portion 51 and the second panel portion 52 (see FIG. 7). The sleeve 46 has a first sleeve part 46a and a second sleeve part 46b The first sleeve part 46a and the second sleeve part 46b are rectangularly shaped. The first sleeve part 46a and the second sleeve part 46b are attached at the perimeter of the first sleeve part 46a and the second sleeve part 46b by, for example, sewing, heat staking, melting or other conventional methods. The panel body 40 is received within the sleeve 46. The sleeve 46 includes a flexible material including, for example, plastic, fabric or other conventional material. Since sleeves are conventional vehicle structures and components, further description is omitted for the sake of brevity.

Referring to FIG. 5, the mirror assembly M includes a mirror housing Mc, a mirror glass Md and optionally a light source Me. The mirror housing Mc is ridged and surrounds the mirror glass Md. The mirror glass Md is attached to the mirror housing Mc. The first panel part 61 includes a mirror assembly M attached to the first exterior surface 61c (see FIG. 7). The mirror assembly M is attached to the first panel part 61 by, for example, fasteners, clips or other conventional methods. Since mirror assemblies are conventional vehicle structures and components, further description is omitted for the sake of brevity.

A description of the assembly process for the sunvisor assembly 20 is now provided with specific reference to FIGS. 3-8.

To assemble the sunvisor assembly 20, the first panel part 61 is overlayed on top of the second panel part 62 (see FIG. 7). The projections 68 of the first snap fit connection portions 64 of the first panel part 61 are received by the catches 70 of the second snap fit connections 72 of the second panel part 62. The L-shaped shaft member 76 is received by the opening extending along the first side 40c of the panel body 40 (see FIG. 3).

The panel body 40 is received within the sleeve 46 (see FIG. 7). The sleeve 46 is attached around the panel body 40 by, for example, sewing, heat staking, end melting or other conventional methods. The mirror assembly M is attached to the exterior surface of first panel part 61 by, for example, fasteners, clips or other conventional methods (see FIG. 5). The base member 42a of the first vehicle attachment 42 is secured to the headliner 16 and the roof structure 14 (see FIG. 3). The attachment rod 44A of the second vehicle attachment 44 is received within the second attachment end 66b of projection member 66.

### Second Embodiment

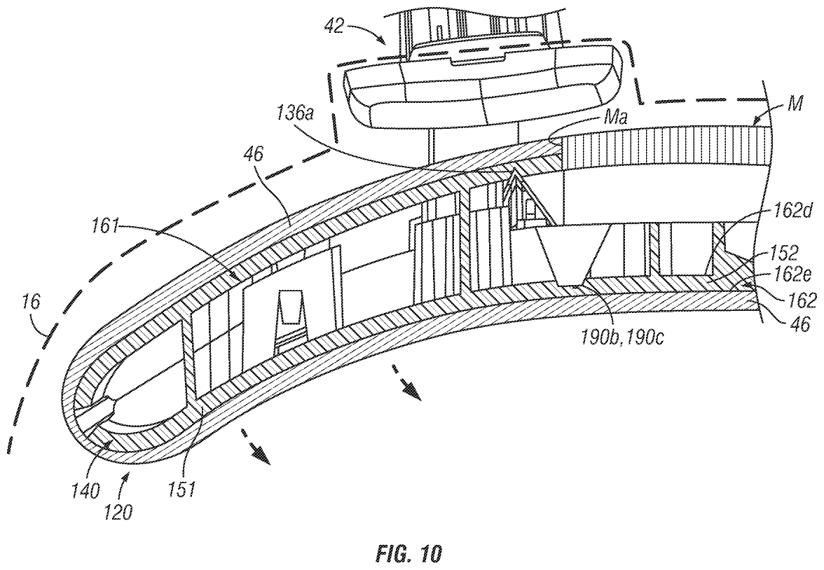

Referring now to FIG. 10, a vehicle sunvisor assembly in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with 100 series numbers.

Referring to FIG. 10, the sunvisor assembly 120 includes a panel body 140. The panel body 140 basically includes a first panel portion 151 and a second panel portion 152. In the second embodiment, the panel body 140 further includes a connection 186 connecting the first panel portion 151 to the second panel portion 152. The connection 186 is configured to deform in response to a force greater than a predetermined amount being applied to the first panel portion 151. Further, the panel body 140 includes a first panel part 161 and a second panel part 162.

Referring to FIG. 10, the connection 186 includes a first frangible section 136a and a second living hinge section 190b. The first interior surface 161d of the first panel part 161 includes the first frangible section 136a. The second interior surface 162d of the second panel part 162 includes the second living hinge section 190b. The second living hinge section 190b includes a channel 190c, sequence of channels or parallel channels within the second interior surface 162d of the second body 162a of the second panel part 162. The second living hinge section 190b is more easily bent than portions of the second body 162a of the second panel part 162 that are adjacent to the second living hinge section 190b. The second living hinge section 190b dissipates energy from the curtain airbag 118 when the curtain airbag 118 is deployed. As shown in FIG. 10, a cross section of the channel 190c taken transversely to the channel 190c has a rectangular shape. Alternatively, other conventional living hinge shapes can be used.

Alternatively, while FIG. 10 shows the second interior surface 162a of the second panel part 162 includes a living hinge 190b and the first interior surface 161d of the first panel part 161 includes a frangible section 136a, in an alternate embodiment the first panel part 161 includes a living hinge 190a and the second panel part 162 includes a frangible section 136b.

Hence, as shown in FIG. 10, the panel body 140 includes at least one of a frangible connection 136 and a living hinge connection 190 that connects the first panel portion 151 to the second panel portion 152. In other words, one of the first panel part 161 and the second panel part 162 includes a frangible section 136a and the other of the first panel part 161 and the second panel part 162 includes a living hinge section 190b. Stated differently, at least one of the first interior surface 161d of the first panel part 161 and the second interior surface 162d of the second panel part 162 includes a frangible section 136a or a living hinge section 190b.

### Third Embodiment

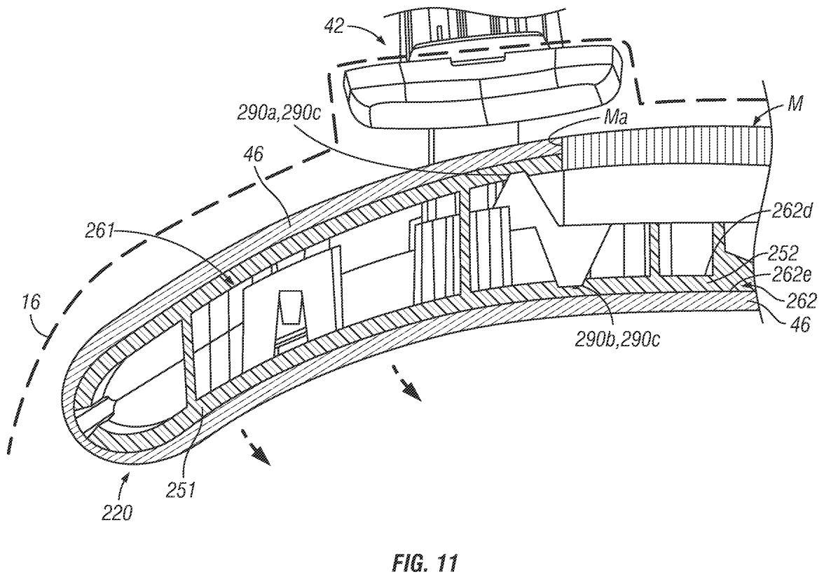

Referring now to FIG. 11, a vehicle sunvisor assembly in accordance with a third embodiment will now be explained. In view of the similarity between the first, second and third embodiments, the parts of the third embodiment that are identical to the parts of the first embodiment will be given the same reference numerals as the parts of the first and second embodiments. Moreover, the descriptions of the parts of the third embodiment that are identical to the parts of the first and second embodiments may be omitted for the sake of brevity. The parts of the third embodiment that differ from the parts of the first and second embodiments will be indicated with 200 series numerals.

Referring to FIG. 11, the sunvisor assembly 220 includes a panel body 240. The panel body 240 basically includes a first panel portion 251 and a second panel portion 252. In the second embodiment, the panel body 240 further includes at least one living hinge connection 290 that connects the first panel portion 251 to the second panel portion 252. The at least one living hinge connection 290 is configured to bend in response to a force greater than a predetermined amount being applied to the first panel portion 251. Further, the panel body 240 includes a first panel part 261 and a second panel part 262.

Referring to FIG. 11, the living hinge connection 290 includes a first living hinge section 290a and a second living hinge section 290b. The first interior surface 261d of the first panel part 261 includes the living hinge section 290a and the second interior surface 262d of the second panel part 262 includes the living hinge section 290b. The first living hinge section 290a includes a channel 290c, sequence of channels or parallel channels within the first interior surface 261d of the first panel part 261. The second living hinge section 290b includes a channel 290c, sequence of channels or parallel channels within the second interior surface 262d of the second panel part 262. Stated differently, the living hinge connection 290 includes the first living hinge section 290a in the first panel part 261 and the second living hinge section 290b in the second panel part 262.

The first living hinge section 290a is more easily bent than portions of the first body 261a of the first panel part 261 that are adjacent to the first living hinge section 290a. The first living hinge section 290a and the second living hinge section 290b dissipate energy from the curtain airbag 18 when the curtain airbag 18 is deployed (see FIGS. 7 and 11).

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle sunvisor assembly. Accordingly, these terms, as utilized to describe the present invention should be interpreted relative to a vehicle equipped with the vehicle sunvisor assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the vehicle field from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle sunvisor assembly comprising:
a panel body including a first panel portion and a second panel portion, the panel body having a first side and a second side spaced from the first side;
a first vehicle attachment movably coupled to a first end of the first side, and configured to be attached to a vehicle body structure; and
a second vehicle attachment coupled adjacent a second end of the first side, and configured to be releasably coupled to the vehicle body structure;
the panel body further including at least one of a frangible connection and a living hinge connection that connects the first panel portion to the second panel portion, the frangible connection being configured to break in response to a force greater than a predetermined amount being applied to the first panel portion, and the living hinge connection being configured to bend in response to a force greater than a predetermined amount being applied to the first panel portion.

2. The vehicle sunvisor panel according to claim 1, wherein
the panel body includes a first panel part at least partly defining the first panel portion and the second panel portion and a second panel part at least partly defining the first panel portion and the second panel portion.

3. The vehicle sunvisor panel according to claim 2, wherein
the first panel part of the panel body and the second panel part of the panel body are a unitary.

4. The vehicle sunvisor panel according to claim 2, wherein
the first panel part includes a first exterior surface and a first interior surface,
the second panel part includes a second exterior surface and a second interior surface, and
one of the first interior surface and the second interior surface includes a plurality of projections and the other of the first interior surface and the second interior surface includes a plurality of catches for receiving the projections to form a snap-fit connection.

5. The vehicle sunvisor panel according to claim 2, wherein
the frangible connection includes a first frangible section in the first panel part.

6. The vehicle sunvisor panel according to claim 5, wherein
the frangible connection includes a second frangible section in the second panel part.

7. The vehicle sunvisor panel according to claim 6, wherein
the first frangible section and the second frangible section are laterally offset.

8. The vehicle sunvisor panel according to claim 6, wherein
the second panel part includes a mirror assembly on the second exterior surface.

9. The vehicle sunvisor panel according to claim 8, wherein
the mirror assembly having a first end and a second end, the second end of the mirror assembly is spaced from the first frangible section by a first lateral distance, the second end of the mirror assembly is spaced from the second frangible section by a second lateral distance, the first lateral distance is greater than the second lateral distance.

10. The vehicle sunvisor panel according to claim 5, wherein
the first panel part includes a first exterior surface and a first interior surface, the first frangible section includes a channel on the first interior surface of the first panel part.

11. The vehicle sunvisor panel according to claim 10, wherein
a cross section of the channel taken transversely to the channel has a V shape or a U shape.

12. The vehicle sunvisor panel according to claim 1, wherein
the first vehicle attachment includes an L-shaped shaft member having a first end portion and a second end portion, the second end portion of the L-shaped shaft member extends into an opening extending along the first side of the panel body, the panel body is configured to pivot about the first end portion of the L-shaped shaft member.

13. The vehicle sunvisor panel according to claim 1, wherein
the second vehicle attachment includes an attachment rod extending parallel to the first side of the panel body.

14. The vehicle sunvisor panel according to claim 2, wherein
the first panel part includes a first exterior surface and a first interior surface,
the second panel part includes a second exterior surface and a second interior surface,
the frangible section or the living hinge section is provided to at least one of the first interior surface and the second interior surface,
at least one of the first interior surface of the first panel part and the second interior surface of the second panel part includes at least one interior reinforcement wall extending transverse to the frangible section or the living hinge section, the at least one interior reinforcement wall is discontinuous adjacent to the frangible section or the living hinge section.

15. The vehicle sunvisor panel according to claim 2, wherein
the first panel part includes a first exterior surface and a first interior surface,
the second panel part includes a second exterior surface and a second interior surface,
the frangible section or a living hinge section is provided to at least one of the first interior surface and the second interior surface, and
the frangible section or the living hinge section extends in a direction that is approximately parallel to a medial line of a section of the stowed curtain airbag that is adjacent to the sunvisor panel where the sunvisor panel is in a panel body stored configuration.

16. The vehicle sunvisor panel according to claim 1, further comprising
a sleeve surrounds the first panel part and the second panel part, the sleeve includes a flexible material.

17. The vehicle sunvisor panel according to claim 2, wherein
one of the first panel part and the second panel part includes a frangible section and the other of the first panel part and the second panel part includes a living hinge section.

18. The vehicle sunvisor panel according to claim 2, wherein
the living hinge connection includes a first living hinge section in the first panel part and a second living hinge section in the second panel part.

19. A vehicle comprising the vehicle sunvisor panel according to claim 1, and further comprising
the vehicle body structure including a roof structure;
a curtain airbag attached to an area adjacent to the roof structure; and
a headliner attached below the curtain airbag,
the curtain airbag having a stowed configuration concealed above the headliner and an expanded configuration extending below the headliner, the curtain airbag being configured to apply at least the predetermined force to the first panel portion as the curtain airbag transitions from the stowed configuration to the expanded configuration.
